(19) United States
(12) Patent Application Publication
(10) Pub. No.: US 2011/0141930 A1
(43) Pub. Date: Jun. 16, 2011

(54) BASEBAND COMPENSATION FOR PHASE DISCONTINUITIES IN RADIO FREQUENCY COMMUNICATION DEVICES

(75) Inventors: Sumit Verma, San Diego, CA (US); Vijay K. Chellappa, San Diego, CA (US); Bhushan Shanti Asuri, San Diego, CA (US)

(73) Assignee: QUALCOMM INCORPORATED, San Diego, CA (US)

(21) Appl. No.: 12/870,562

(22) Filed: Aug. 27, 2010

Related U.S. Application Data
(60) Provisional application No. 61/285,939, filed on Dec. 11, 2009.

(51) Int. Cl. H04W 24/00

(52) U.S. Cl. 370/252

(57) ABSTRACT

A method for compensating for phase discontinuities on a communication device is described. A communication device may determine a desired output power. The communication device may determine a Digital-to-Analog Converter (DAC) gain corresponding to the desired output power. The communication device may determine a cumulative phase offset based on the DAC gain. The communication device may apply the DAC gain. The communication device may apply a phase compensation to a rotator to adjust for the cumulative phase offset.

### RELATED APPLICATIONS

This application is related to and claims priority from U.S. Provisional Patent Application Ser. No. 61/285,939, filed Jan. 11, 2010, for “Baseband Compensation for Phase Discontinuities in Radio Frequency Communication Devices.”

### TECHNICAL FIELD

The present disclosure relates generally to communication systems. More specifically, the present disclosure relates to baseband compensation for phase discontinuities in radio frequency communication devices.

### BACKGROUND

Wireless communication systems are widely deployed to provide various types of communication content such as voice, video, data, and so on. These systems may be multiple-access systems capable of supporting simultaneous communication of multiple communication devices with one or more base stations.

The communication devices in wireless communication systems may be required to operate at various transmission power levels. For example, a cell phone may be required to reduce its transmission power while communicating with a base station. This power reduction may provide certain benefits, such as less Radio Frequency (RF) interference present in the communication system and extended battery life for the communication device. However, communication devices may also need to maintain at least a minimum transmission power to ensure reliable communications. As a result, many communication devices are designed to operate at various power levels, increasing signal power when needed to maintain reliable communications or reducing signal power when possible.

When signal power is increased or reduced, phase discontinuities may be introduced into the communication signal. If the phase discontinuities become too severe, a base station may have difficulty in decoding and/or tracking the signal, for example. Furthermore, communications devices may be designed to operate in accordance with a specification. For example, some wireless devices may be designed to operate in accordance with 3^{rd} Generation Partnership Project (3GPP) or 3^{rd} Generation Partnership Project 2 (3GPP2) specifications (e.g. UMTS release 8). As wireless technology progresses and higher data rates and higher order modulation schemes are desired, some specifications may have more stringent phase discontinuity requirements.

For the reasons discussed above, improved systems and methods for baseband compensation for radio frequency phase discontinuities in communication devices may be beneficial. Improved systems and methods are disclosed herein.

### SUMMARY

A method for compensating for phase discontinuities on a communication device is disclosed. The method includes determining a desired output power and determining a Digital-to-Analog Converter (DAC) gain corresponding to the desired output power on a communication device. The method also includes determining a cumulative phase offset based on the DAC gain or the desired output power on the communication device. The DAC gain is applied to the communication device. A phase compensation is applied to a rotator to adjust for the cumulative phase offset on the communication device.

The phase compensation may be synchronized with the application of the DAC gain. The phase discontinuities may occur as a result of applying the DAC gain to the communication device.

The method may include determining a gain of transmitter components and determining the cumulative phase offset that is further based on the gain of the transmitter components. The method may further include applying the gain of the transmitter components to the communication device and applying the phase compensation to the rotator to adjust for the cumulative phase offset that is further based on the gain of the transmitter components. The phase compensation may be synchronized with the application of the gain of the transmitter components. The phase discontinuities may occur as a result of applying the gain of the transmitter components to the communication device.

The transmitter components may include a baseband filter, an upconverter, a Voltage Controlled Oscillator/Phase Lock Loop (VCO/PLL) and/or a driver amplifier. The phase discontinuities may occur as a result of activating or deactivating at least one of the transmitter components or as a result of activating or deactivating at least one sub-block of the transmitter components.

The method may also include determining a Power Amplifier (PA) gain and the cumulative phase offset that is further based on the PA gain. The method may further include applying the PA gain to the communication device and applying the phase compensation to the rotator to adjust for the cumulative phase offset that is further based on the PA gain. The phase compensation may be synchronized with the application of the PA gain. The phase discontinuities may occur as a result of applying the PA gain to the communication device. The phase compensation may be applied via a single phase compensation path in the baseband of the communication device.

The phase compensation may be fine phase compensation. The communication device may be a wireless communication device. The communication device may be a base station. The phase compensation may be always applied.

A communication device configured to compensate for phase discontinuities is also disclosed. The communication device includes a modulator configured for modulating a baseband signal that includes a rotator configured for rotating a phase of the baseband signal. The communication device further includes a Digital-to-Analog Converter (DAC) configured for converting a modulated digital signal to an analog signal and a transmit gain controller configured to control a DAC gain and to provide a phase offset to the rotator in the modulator in order to compensate for a phase shift in a transmission chain. The transmit gain controller selects the DAC gain and phase offset based on a desired output power.

The communication device may also include transmitter components configured to format a signal for transmission. The transmit gain controller may be further configured to control a gain of the transmitter components and to provide the phase offset to the rotator in the modulator in order to compensate for the phase shift in the transmission chain. The transmit gain controller may further select the gain of the transmitter components based on the desired output power.

The communication device may also include a power amplifier (PA) configured to amplify a signal for transmission. The transmit gain controller may be further configured to control a PA gain and to provide the phase offset to the rotator in the modulator in order to compensate for the phase shift in the transmission chain. The transmit gain controller may further select the PA gain based on the desired output power.

A computer-program product for compensating for phase discontinuities on a communication device is also disclosed. The computer-program product includes instructions on a non-transitory computer-readable medium. The instructions include code for determining a desired output power and code for determining a Digital-to-Analog Converter (DAC) gain corresponding to the desired output power. The instructions also include code for determining a cumulative phase offset based on the DAC gain, code for applying the DAC gain and code for applying a phase compensation to a rotator to adjust for the cumulative phase offset.

### BRIEF DESCRIPTION OF THE DRAWINGS

FIG. 1 illustrates a wireless communication system;

FIG. 2 is a block diagram illustrating a communication system in which baseband compensation for radio frequency phase discontinuities may be implemented;

FIG. 3 is a block diagram illustrating a transmission chain and a reception chain;

FIG. 4 is a block diagram illustrating modules of a transmission chain in a communication device;

FIG. 5 is a block diagram illustrating a more detailed example of a transmission chain and a transmit gain controller;

FIG. 6 depicts a block diagram illustrating the operation of a phase rotator;

FIG. 7 is a flow diagram illustrating a method for baseband compensation for phase discontinuities in radio frequency communication devices;

FIG. 8 illustrates certain components that may be included within a wireless communication device; and

FIG. 9 illustrates certain components that may be included within a base station.

### DETAILED DESCRIPTION

Phase discontinuity requirements, according to some specifications, are becoming increasingly difficult to meet with higher data rates and higher-order modulation schemes. At the same time, there is an increased focus on the development of Radio Frequency Integrated Circuits (RFICs) and Power Amplifiers (PAs) for wireless communication devices that are low cost, consume low current and have less die area. This motivates using several changes in the transmitter lineup based on the output power such as PA gain changes, supply changes to RFIC blocks, turning certain transmitter components on and off, etc. Most of these changes may result in phase discontinuities in the transmitted signal, which may make it difficult to meet phase discontinuity requirements.

As was discussed above, when a communication device changes its transmitted power level, phase discontinuities may be introduced into the transmitted signal. More specifically, the transmitted power level may be adjusted according to the gain of several components of a transmission chain by a transmit gain controller in a communication device. The “transmission chain” as discussed herein includes modules or components that may prepare and/or format information for wireless transmission. When the gain of one or more of these components is adjusted, the phase of the transmitted signal may be affected (i.e. possibly introducing phase discontinuities in the transmitted signal). One approach to compensate for phase discontinuities is to adjust baseband phase to compensate for phase changes corresponding to gain changes in the power amplifier (PA). For example, the PA may comprise several stages of PAs that may be selectively included or excluded from the transmission chain. However, the PA (which may comprise several PAs) may only be one component in the transmission chain that has an adjustable gain and corresponding phase change. For example, a communication device may also include a Digital-to-Analog Converter (DAC) and other transmitter components. The transmitter components may also have respective adjustable gains and corresponding phase shifts. Examples of components include a baseband filter, upconverter, driver amplifier and others. Thus, adjusting the gain in the DAC and/or each of these components may also introduce a phase shift in the transmitted signal. A transmit gain controller included in the communication device may store anticipated or measured phase shifts depending on the gain settings for the DAC, the transmitter components and the PA. The transmit gain controller may communicate a phase compensation setting to a rotator in a modulator of the communication device that compensates for phase shifts. In other words, the rotator in the modulator may be used for synchronized phase compensation. Thus, transmitted phase discontinuities may be reduced or eliminated by synchronizing baseband rotations with changes in the DAC, transmitter components and PA. This approach may allow for phase compensation of phase discontinuities arising from several different types of changes to the transmission chain lineup. That is, in spite of the use of various different transmission gain lineups over the transmitted power dynamic range, a single phase compensation path in the baseband may be used (e.g. by obtaining and using a suitable phase compensation value for each and every configuration of DAC gain, transmitter component gains and PA gain states). The baseband compensation may be synchronized through firmware on the communication device. For example, the firmware may time-align all of the gain changes and the baseband compensation value such that they occur at a slot or sub-slot boundary. More specifically, the changes may be synchronized by ensuring that changes written to different blocks take effect at the same time. This may be implemented through hardware latches and programmable delays in firmware and software. One benefit of the systems and methods disclosed herein is that compensating for the phase discontinuities caused by gain adjustments in the DAC and transmitter components, in addition to those caused by gain adjustments in the PA, may provide fine phase compensation over the entire transmitted dynamic range, even for small changes. Effectively, after phase compensation, the resultant phase discontinuity may only correspond to the variation of the phase discontinuity from its mean.

Various configurations are now described with reference to the Figures, where like reference numbers indicate identical or functionally similar elements. The configurations as generally described and illustrated in the Figures herein could be arranged and designed in a wide variety of different configurations. Thus, the following more detailed description of several configurations, as represented in the Figures, is not intended to limit scope, as claimed, but is merely representative of the configurations.

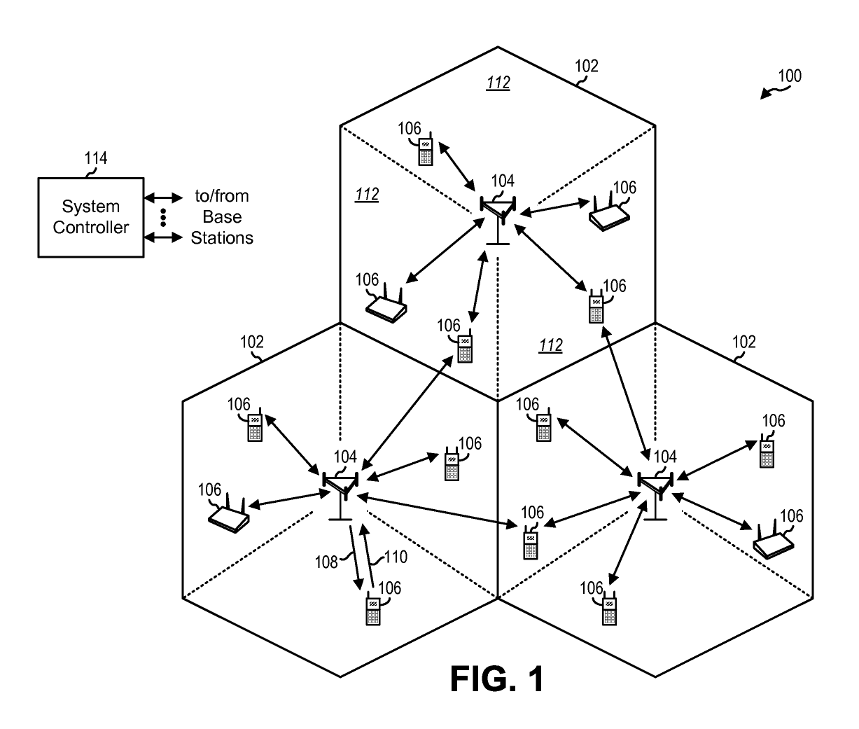

FIG. 1 illustrates a wireless communication system 100. The system 100 provides communication for multiple cells 102, with each cell 102 being serviced by a corresponding base station 104. A base station 104 is a fixed station that communicates with wireless communication devices 106. A base station 104 may alternatively be referred to as an access point, a Node B, an eNode B (“evolved Node B”) or some other similar terminology.

One or more wireless communication devices 106 may be dispersed within the system 100 over time. A wireless communication device 106 is an electronic device that may be used for voice and/or data communication over the wireless communication system 100. A wireless communication device 106 may alternatively be referred to as a mobile station, a user equipment, an access terminal, a subscriber station, a mobile terminal, a remote station, a user terminal, a terminal, a subscriber unit, a mobile device, etc. A wireless communication device 106 may be a cellular phone, a smartphone, a personal digital assistant (PDA), a wireless modem, laptop, netbook, e-book, wireless card or any other suitable device for communicating over the system 100. Both wireless communication devices 106 and base stations 104 may be referred to as “communication devices” herein.

A communication link that facilitates transmission from a base station 104 to a wireless communication device 106 may be referred to as a downlink 108, and a communication link that facilitates transmission from a wireless communication device 106 to a base station 104 may be referred to as an uplink 110. Alternatively, a downlink 108 may be referred to as a forward link or a forward channel, and an uplink 110 may be referred to as a reverse link or a reverse channel. In a frequency division duplex (FDD) system, a downlink 108 can utilize a different frequency band than that used by an uplink 110. In a time division duplex (TDD) system, a downlink 108 and an uplink 110 can utilize a common frequency band.

The resources of the wireless communication system 100 (e.g., bandwidth and transmit power) may be shared among multiple wireless communication devices 106. A variety of multiple access techniques are known, including code division multiple access (CDMA), time division multiple access (TDMA), frequency division multiple access (FDMA), orthogonal frequency division multiple access (OFDMA), single-carrier frequency division multiple access (SC-FDMA), and so forth.

To improve system capacity, a cell 102 may be partitioned into multiple sectors 112. Each sector 112 may be served by a respective base transceiver station (BTS). For a sectorized cell 102, the BTSs for all sectors 112 of that cell 102 are typically co-located within the base station 104 for the cell 102.

For a centralized architecture, a system controller 114 may couple to the base stations 104 and provide coordination and control for the base stations 104. The system controller 114 may be a single network entity or a collection of network entities. For a distributed architecture, base stations 104 may communicate with one another as needed.

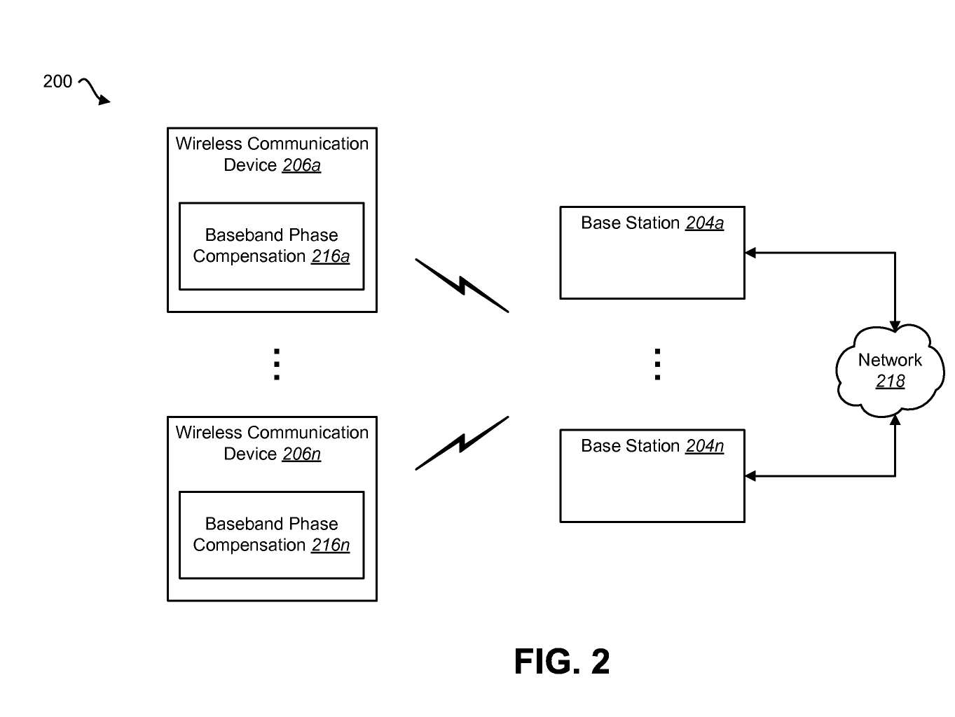

FIG. 2 is a block diagram illustrating a communication system 200 in which methods for baseband compensation for phase discontinuities in radio frequency communication devices may be implemented. One or more wireless communication devices 206a-n may wirelessly communicate with one or more base stations 204a-n. The wireless communication devices 206 and base stations 204 may operate in accordance with a specification. Examples of such specifications include, but are not limited to, the 3GPP or 3GPP2 specifications. The base stations 204 may communicate with a network 218. The network 218 could be, for example, the Internet, a Public Switched Telephone Network (PSTN), a local area network (LAN), wide area network (WAN) or some other type of network. The network 218 may allow a user of a wireless communication device 206 to communicate with other devices or users of other devices. For example, a user of a communication device 206 may call the user of a “land-line” telephone or may call the user of another wireless communication device 206n. A user might also browse the Internet, play a game or complete a financial transaction via the network 218.

Each of the wireless communication devices 206a-n may include a baseband phase compensation module 216a-n. As was discussed above, several components in the wireless communication devices 206 (e.g. PAs, DAC, other components) may cause a phase shift in the transmitted signal when their gains are adjusted. A baseband compensation module 216 may rotate the phase of a baseband signal to compensate for the anticipated phase shift when gains are adjusted. The base stations 204 may also include components that similarly cause phase shifts when their gains are adjusted. A baseband compensation module (not shown) could also be included in a base station 204 in order to ameliorate unwanted phase shifts.

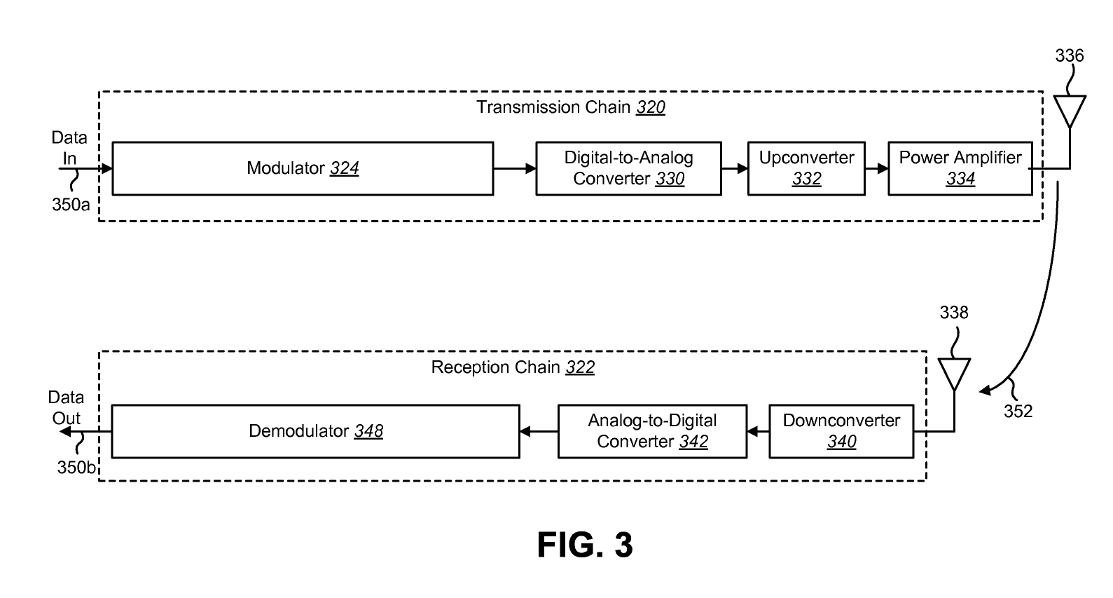

FIG. 3 is a block diagram illustrating a transmission chain 320 and a reception chain 322. The transmission chain 320 and the reception chain 322 may be implemented within a base station 204 or a wireless communication device 206, etc. The transmission chain 320 may include several components or modules.

The transmission chain 320 accepts digital data 350a, converts it to a modulated radio frequency (RF) signal 352 and transmits the signal 352. The transmitted signal 352 is received by another device, such as base station 204 or a wireless communication device 206, which includes a reception chain 322 for processing the signal 352. Thus, the transmission chain 320 and reception chain 322 are both shown in FIG. 3 to illustrate the transmission and reception of a signal, but it is understood that the transmission chain 320 in FIG. 3 is in a different device than the reception chain 322 of FIG. 3. The reception chain 322 receives the RF signal 352 and demodulates it so as to output data 350b that is a reproduction of the input data 350a.

The digital data 350a provided to the transmission chain 320 may be modulated by a modulator 324 to produce a sequence of modulated samples that represent symbols, in accordance with a certain modulation format. The modulator 324 may be part of a Mobile Station Modem (MSM), for example. The modulator 324 may include a Tx pulse-shaping filter and a transmitter (Tx) front-end (not shown). The modulated samples may be filtered by the transmitter (Tx) pulse-shaping filter to produce a sequence of filtered samples. The Tx pulse-shaping filter is a digital filter, which may be implemented as a finite impulse response (FIR) filter.

The Tx front end may process the output of the Tx pulse-shaping filter. The Tx front end may perform functions such as interpolation, predistortion and/or other filtering operations. The filtered samples may be provided to a digital-to-analog converter (DAC) 330, which produces an analog signal representing the modulated and filtered sample sequence at its input. In some configurations, the DAC 330 may also be considered as part of an MSM. The analog signal at the output of the DAC 330 may be upconverted to a suitable radio frequency by an upconverter (UC) 332 and amplified by a power amplifier (PA) 334. In some configurations, a driver amplifier (not shown) may be included between the upconverter 332 and the PA 334. The RF signal 352 may then be transmitted via a transmit antenna 336.

A receive antenna 338 may receive the transmitted signal 352 and provide it to a downconverter 340, which downconverts the signal 352 from RF to a suitable intermediate frequency (IF) or baseband analog signal. In some configurations, an external filter and low noise amplifier (LNA) may be included before the downconverter 340. The analog signal may be digitized by an analog-to-digital converter (ADC) 342, which produces a sequence of digitized samples. The digitized samples may be processed by a demodulator 348, which may include a receiver (Rx) front end (not shown), which may perform functions such as decimation, automatic gain control (AGC) and/or other adaptive filtering operations. The samples may then be filtered by an Rx pulse-shaping filter, which may also be included in the demodulator 348. The Rx pulse-shaping filter is a digital filter, which may be implemented as an FIR filter. The samples at the output of the Rx pulse-shaping filter may be demodulated by the demodulator 348, which outputs data 350b that is ideally a reproduction of the input data 350a provided to the transmission chain 320.

The spectral responses of the Tx pulse-shaping filter and the Rx pulse-shaping filter may have a significant influence on communication performance. For example, the Tx pulse-shaping filter limits the spectral bandwidth of the transmitted signal 352, often determining the level of adjacent channel interference and other spurious emissions generated by the transmission chain 320. When the transmission chain 320 conforms to a particular communication standard, the bandwidth of the transmitted signal 352 is typically specified in the standard, often using a spectral mask, which should not be exceeded.

The Tx pulse-shaping filter and the Rx pulse-shaping filter should be matched to one another. For example, the Tx pulse-shaping filter and the Rx pulse-shaping filter may be implemented so that they each have a root raised cosine (RRC) response, and so that their combined spectral response is a raised cosine (RC) spectral response. Of course, RRC is provided as an example only; the Tx pulse-shaping filter and the Rx pulse-shaping filter do not have to be implemented so that they each have an RRC response. However, they should have the same response such that the Rx pulse-shaping filter is matched to the Tx pulse-shaping filter, so as to maximize the signal-to-noise ratio (SNR).

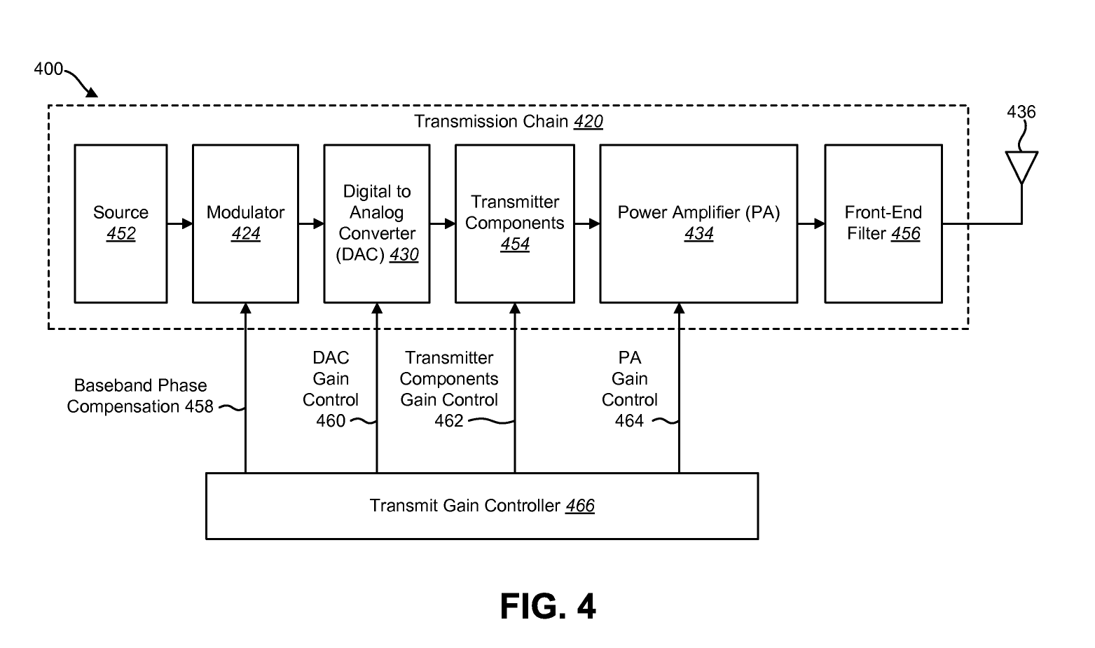

FIG. 4 is a block diagram illustrating modules 400 of a transmission chain 420 in a communication device (e.g. wireless communication device 206 or base station 204). The communication device may include a source 452, modulator 424, Digital-to-Analog Converter (DAC) 430, transmitter components 454, Power Amplifier (PA) 434, front-end filter 456, antenna 436 and a transmit (Tx) gain controller 466. The source 452 may be digital data or a digital signal on the communication device. Examples of the source 452 include a digitized user voice signal or data (e.g. for a phone call), digitized user input data (e.g. digitally formatted text) or other data such as control data to be transmitted. The source 452 data may be fed into a modulator 424. The modulator 424 may format the data into modulated samples that represent the source 452 data. A DAC 430 may receive the samples and convert them into an analog format. That is, the DAC 430 converts digital samples into an analog signal that is sent to other transmitter components 454. The transmitter components 454 may include several components that format the analog signal for transmission. Examples of transmitter components 454 include a baseband filter, upconverter, driver amplifier and others. In one configuration, transmitter components 454 may be implemented on a Radio Transceiver (RTR) Integrated Circuit (IC). Some or all of these transmitter components 454 may be included or omitted from the transmission chain depending on the processing desired for the analog signal. The analog signal may be fed to a PA 434. The PA 434 amplifies the analog signal in preparation for transmission. After amplification, the signal may be passed through a front-end filter 456 and radiated via an antenna 436.

A transmit gain controller 466 may be a software and/or hardware module (e.g. firmware) that is used to control the gain of several modules or components in the communication device. For example, the transmit gain controller 466 controls the gain of the PA 434, the transmitter components 454 and the DAC 430. In the case of the PA 434, the transmit gain controller 466 may adjust the voltage gain of a PA 434, or may switch PA stages into and out of the transmission chain. Each of the PA stages may introduce a corresponding phase shift into the transmitted signal when added to the transmission chain 420. Thus, the transmit gain controller 466 may be able to anticipate transmitted signal phase changes when switching PA stages into and out of the transmission chain. The transmit gain controller 466 may adjust the PA 434 gain via a PA gain control signal 464. When adjusting the PA 434 gain, the transmit gain controller 466 may send a baseband phase compensation signal 458 to the modulator 424. The baseband phase compensation signal 458 may indicate the amount of phase shift that will be introduced into the transmitted signal. In other words, the baseband phase compensation signal 458 indicates the amount of phase needed to offset or compensate for the anticipated phase change in the transmitted signal. The modulator 424 may rotate the signal in order to compensate for the anticipated phase changes.

Although the phase changes introduced by PA 434 gain adjustments may be significant, gain adjustments in the DAC 430 and transmitter components 454 may also introduce phase shifts into the transmitted signal. The phase shifts introduced by PA 434 gain adjustments may be large phase shifts, while the phase shifts introduced by gain adjustments in the DAC 430 and transmitter components 454 may be also be large or comparatively smaller or “finer” phase shifts. The transmit gain controller 466 may control the gain of the transmitter components through a transmitted components gain control signal 462. The transmit gain controller 466 may also control the gain of the DAC 430 through a DAC gain control signal 460. When the transmit gain controller 466 adjusts the gain of the DAC 430 or transmitter components 454, it may anticipate phase shifts introduced into the transmitted signal corresponding to the gain changes. The transmit gain controller 466 may then send a baseband phase compensation signal 458 that indicates the amount of anticipated phase shift introduced to the transmitted signal as a result of the gain changes. The modulator 424 may rotate the phase of the signal in order to compensate for the anticipated phase shift. Thus, phase discontinuities in the transmitted signal may be reduced or eliminated. In particular, compensating for phase discontinuities resulting from “fine” gain adjustments in the DAC 430 and transmitter components 454 may reduce or eliminate phase discontinuities in the transmitted signal. “Fine” gain adjustments may result in “fine” changes of 1 dB in power, for example. Compensating for fine gain adjustments (e.g. or 1 dB “fine” power control adjustments) may ameliorate even phase discontinuities of 1 degree. This may provide greater phase control than can be had by adjusting for phase shifts caused by the PA 434 alone.

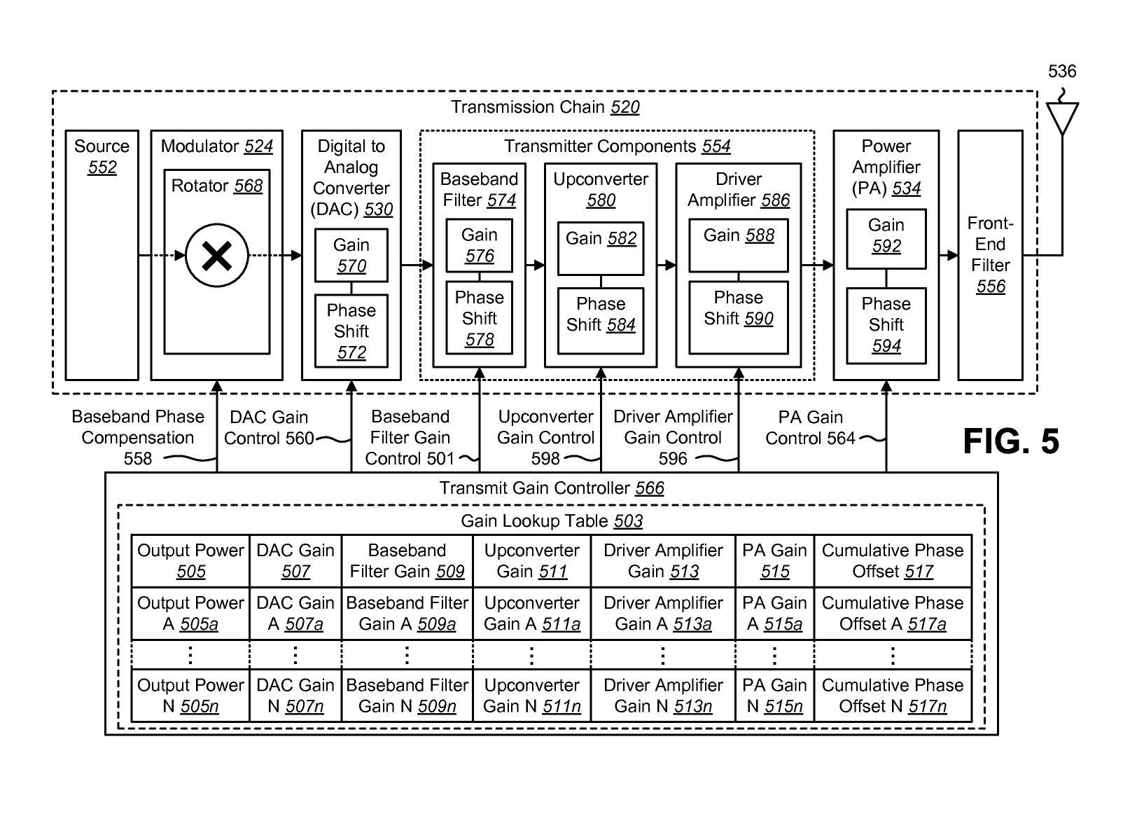

FIG. 5 is a block diagram illustrating a more detailed example of a transmission chain 520 and a transmit gain controller 566. Performance requirements may differ over the transmitted power dynamic range. At higher powers, received band noise and Adjacent Channel Leakage Ratio (ACLR) requirements may be difficult to meet (e.g. for designs that do not include a SAW filter). That is, the transmission chain 520 may have to burn a “high” current in order to meet the requirements. At lower power, requirements may be easier to meet, though burning as little current as possible may be a goal (e.g. for talk-time improvement). In order to support such contrasting demands over the transmitted power dynamic range, certain features may need to be supported. For example, the supply voltage for certain blocks (e.g. transmit Voltage Controlled Oscillator (VCO) to improve phase noise) may need to be increased at higher output powers. Additional sub-blocks, modules or blocks may have to be activated at different points on the transmission chain 520 at higher output powers. For instance, some modules or sub-blocks may be omitted at lower powers that may be activated at higher powers (i.e. see the discussion about the pre-driver amplifier below). Also, the DAC 530 reference current (Iref) may need to be increased at higher output powers for input into the transmitter components 554. Many of these changes may result in abrupt phase changes in the transmitted signal unless they are compensated for. It should also be noted that transmitter component 554 gain control may be binary-coded gain (i.e. instead of “thermometer-coded” gain control) for multiple modules or blocks (e.g. for steps of 1 dB in output power). Thus, even a small change in gain may require adding or omitting several transmitter component 554 sub-blocks, modules or blocks (referred to below). This can cause significant changes in the cascaded transmission chain 520 lineup which, in turn, can cause large phase discontinuities in the transmitted signal.

A baseband digital source signal or data 552 may be input into the modulator 524. The modulator 524 may include a rotator 568. The rotator 568 may be capable of rotating the baseband signal phase between −180 and 180 degrees. The rotator 568 may also have a particular resolution. In one possible configuration, the rotator may have a resolution of 30 degrees. This phase rotation may be accomplished through a complex multiplication. For example, the rotation may be represented by (I+jQ)(cos θ−j sin θ), where I is the in-phase component of the signal, Q is the quadrature component of the signal, θ is the phase angle rotation and j is \sqrt{−1}. This may be equivalently expressed as (I+jQ)e^{(-jθ)}. As one example, the rotator 568 may be a Coordinate Rotation Digital Computer (CORDIC). The rotator 568 may accomplish a phase rotation of a digital signal in a single path. For example, the rotator 568 may apply the phase rotation directly to a single signal path, rather than switching to a separate compensated signal path. The phase compensation may thus be applied more efficiently to the signal (in a single path), rather than switching in a separate compensation path. This phase rotation may be consistently (i.e. and not selectively) applied to the signal. In other words, the phase rotator 568 may consistently operate on (i.e. or applied to) the signal path, even at a phase rotation of 0 degrees. Alternatively, the phase rotation may be selectively applied. The modulator 524 outputs a modulated digital signal that is fed to the DAC 530. The DAC 530 may include a gain 570 and a phase shift 572 corresponding to the gain 570. The DAC gain 570 is a measure of the amount of signal amplification provided to the signal passing though the DAC. The DAC gain 570 may be adjustable. As the DAC gain 570 is adjusted, its corresponding DAC phase shift 572 may also change. The DAC 530 output may be optionally fed into transmitter components 554.

Transmitter components 554 may include several components such as a baseband filter 574, upconverter 580, Voltage Controlled Oscillator (VCO)/Phase-Lock Loop (PLL) (not shown), driver amplifier 586, etc. Each of the components may have a corresponding gain and phase shift. In this example, the transmitter components 554 include a baseband filter 574, upconverter 580 and a driver amplifier 586. The baseband filter 574 may be used to remove out-of-band energy (e.g. unwanted energy at higher frequencies) and get rid of DAC 530 images. The baseband filter 574 includes a baseband filter gain 576 and a corresponding baseband filter phase shift 578. The filter phase shift 578 varies as the baseband filter gain 576 is adjusted. The signal may be passed to an upconverter 580. The upconverter 580 upconverts the signal into a higher frequency range. That is, the upconverter 580 may multiply the signal with a higher frequency carrier signal, thereby shifting a baseband signal to a higher frequency. The upconverter 580 includes an adjustable upconverter gain 582 and a corresponding upconverter phase shift 584. In one configuration, the upconverter has 3 sub-blocks. The first of the blocks adds a 1× gain step, the second adds a 2× gain step and the third adds a 4× gain step. Thus, by switching sub-blocks into and out of the transmission chain 520, the upconverter 580 may add anywhere from a 1× to 7× gain to the transmitted signal. This illustrates how several sub-blocks may need to be added or omitted (e.g. 1× and 2× blocks would have to be omitted and the 4× block added to change gain from 3× to 4×) for even a small gain change. The upconverter phase shift 584 varies as the upconverter gain 582 is adjusted. The signal may be fed into a driver amplifier 586 (DA). The DA 586 may be used to amplify the signal at the output of the upconverter 580 such that the signal at the output of the transmitter components 554 is at a desired output power. The DA 586 may comprise a pre-DA and a DA. For example, the pre-DA and the DA may have different noise, current consumption and/or linearity characteristics. In one configuration, the pre-DA might be bypassed at lower output powers, though it may be used at higher output powers. Similar to other modules included in the transmitter components 554, the driver amplifier 586 includes a driver amplifier gain 588 and a corresponding phase shift 590. Accordingly, the driver amplifier gain 588 may be adjusted, and when adjusted, a corresponding phase shift change 590 may occur. The signal may be passed to a PA 534 in preparation for transmission.

As discussed above, the PA 534 may amplify the outgoing signal. This can be accomplished, for example, by switching PA stages into and out of the signal path. That is, multiple gain-state designs may be used for current optimization (e.g. between current usage in the transmitter components 554 in addition to the PA 534). The PA 534 includes a PA gain 592 and a corresponding phase shift 594. For example, low-cost (e.g. PA 534) designs may not include phase compensation circuitry to compensate for phase discontinuities due to gain state change. As the PA gain 592 is adjusted, changes in the PA phase shift 594 may occur. That is, PA gain 592 state switching may result in a significant phase change due to the PA 534 itself, as well as a large change in transmitter component 554 gain (and output power) to compensate for the PA gain 592 difference. Before the signal is transmitted, it may be passed through a front-end filter 556. The front-end filter 556 may include a duplexer and switchplexer. The front-end filter 556 may be a passive filter that attenuates the signal. The front-end filter 556 may be used for filtering unwanted energy from the signal (e.g. meeting emissions requirements). The signal may be radiated via an antenna 536.

The transmit gain controller 566 may generally control or adjust the gain of modules in the transmission chain. The transmit gain controller 566 may change the gain line-up of modules in the transmission chain 520 over a transmitted power dynamic range. For example, the transmit gain controller 566 may control the DAC gain 570, the baseband filter gain 576, the upconverter gain 582, the driver amplifier gain 588 and the PA gain 592. More specifically, the transmit gain controller 566 may send a DAC gain control signal 560 to the DAC 530, a baseband filter gain control signal 501 to the baseband filter 574, an upconverter gain control signal 598 to the upconverter 580, a driver amplifier gain control signal 596 to the driver amplifier 586 and a PA gain control signal 564 to the PA 534. Each of the gain control signals may comprise instructions, such as digital code words used by the corresponding modules to adjust the gain of each module. More specifically, the control signals may be digital instructions corresponding to different voltages or currents (e.g. DAC reference current (Iref)) that are interpreted by their corresponding modules. For example, the DAC 530 may include a current mirror with a particular current mirror ratio. The current mirror ratio may be adjusted in order to change the amount of electrical current flowing into the DAC 530. The DAC gain 570 will vary with the amount of current provided to the DAC 530. Thus, the DAC gain 530 may be adjusted by varying the current mirror ratio in the DAC 530. This current mirror ratio may be varied via the DAC gain control signal 560. As another example, the driver amplifier gain control signal 596 may be a change in supply voltage to the driver amplifier 586. Another example is where the PA gain control signal 564 is an instruction that notifies the PA 534 to add or remove particular PA stages to or from the signal path, respectively.

The transmit gain controller 566 may include a gain lookup table 503. The gain lookup table 503 may generally include a number of desired output powers 505, gains for modules in the transmission chain 507, 509, 511, 513, 515 used to achieve the desired output powers 505 and cumulative phase offsets 517 corresponding to the gains 507, 509, 511, 513, 515 and desired output powers 505. The desired output powers 505 may be measured at the antenna (e.g. antenna connector). The mapping of the antenna power may be achieved by calibrating the communication device. The gains 507, 509, 511, 513, 515 in the gain lookup table 503 may be pre-programmed into the communication device. The gain lookup table 503 may include a set of gains 507, 509, 511, 513, 515 for each possible desired output power 505. In the example illustrated in FIG. 5, the gain lookup table 503 includes several desired output powers 505a-n. Each of the output powers 505a-n corresponds to a combination of gain settings for each of the applicable modules in the transmit chain. Here, the DAC gains 507a-n, baseband filter gains 509a-n, upconverter gains 511a-n, driver amplifier gains 513a-n and PA gains 515a-n each correspond to desired output powers 505a-n and cumulative phase offsets 517a-n. Alternatively or in addition, the gain lookup table 503 may include gains for other modules in the transmit chain and/or individual phase offsets corresponding to each module in the transmission chain 520. The cumulative phase offsets 517 and/or individual phase offsets may be predetermined and stored in the table, or may be measured or determined by the communication device. For example, the communication device may periodically measure the cumulative phase offsets 517 at different gains at the output of the transmit chain 520 or front-end filter 556 and store the measured phase shifts in the gain lookup table 503. The cumulative phase offsets 517 reflect the phase discontinuities resulting from the gain settings in the modules of the transmission chain 520. For example, the phase shifts 572, 578, 584, 590, 594 may combine to cause a phase discontinuity at the output of the PA 534 if not compensated for. The cumulative phase offsets 517 may be measures of the phase discontinuities in phase angle. The cumulative phase offsets 517 may be recorded and/or communicated in terms of the actual phase discontinuities or in terms of the amount of phase to compensate for the phase discontinuities. For example, the phase discontinuity or cumulative phase offsets 517 may be communicated through a digital word to the rotator 568, which may shift the phase of the signal accordingly.

When a change in the output power 505 of a communication device is desired, the communication device may look up the desired output power 505 in the gain lookup table 503. The communication device may apply the respective gains 507, 509, 511, 513, 515 in the gain lookup table 503 corresponding to the desired output power 505. The communication device may also apply the cumulative phase offset 517 corresponding to the desired output power 505 via a baseband phase compensation signal 558. The baseband phase compensation signal 558 may indicate to the rotator 568 the amount of phase rotation needed to compensate for the cumulative phase offset 517 resulting from the corresponding module gains 507, 509, 511, 513, 515 in the gain lookup table 503. It should be noted that the cumulative phase offset 517 could be stored and/or communicated in terms of a phase shift (e.g. phase angle).

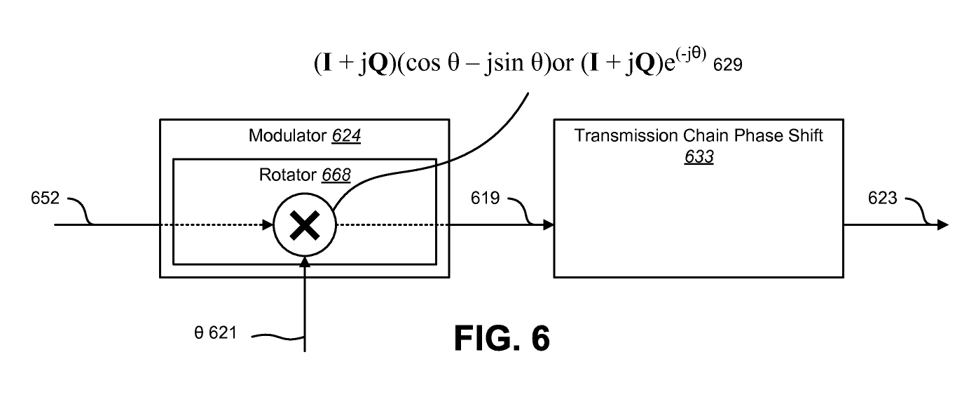

FIG. 6 depicts a block diagram illustrating the operation of a phase rotator 668. The source data 652 is input into the modulator 624. The rotator 668 within the modulator 624 may perform a complex multiplication represented by the equation 629 shown. This rotates the phase of the baseband signal 652 in anticipation of the transmission chain phase shift 633. In other words, the rotator 668 receives a phase θ 621 and applies it to the baseband signal 652. The phase θ 621 compensates for a phase shift imparted to the signal 619 as it passes through the transmission chain phase shift 633. As a result, the output signal 623 exhibits reduced (or no) phase discontinuity.

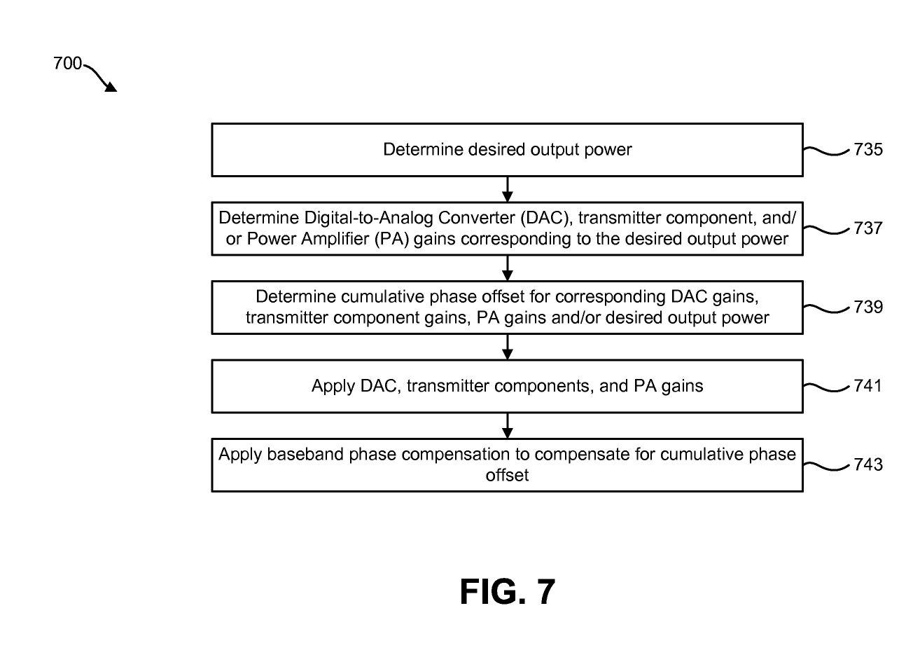

FIG. 7 is a flow diagram illustrating a method 700 for baseband compensation for phase discontinuities in radio frequency communication devices. A communication device (e.g. wireless communication device 106, base station 104, etc.) may determine 735 a desired output power. For example, a wireless communication device 106 may receive a command from a base station 104 to reduce or increase output power by a certain amount. In another example, the wireless communication device 106 might determine 735 without a command that it can (and should) reduce or increase output power. The communication device may determine 737 a DAC gain 570, transmitter component gains 576, 582, 588, and/or PA gain 592 corresponding to the desired output power 505. For example, the communication device looks up the DAC gain 507, baseband filter gain 509, upconverter gain 511, driver amplifier gain 513 and/or PA gain 515 corresponding to the desired output power 505 in the gain lookup table 503. The communication device may determine 739 the cumulative phase offset 517 for corresponding DAC gain 507, baseband filter gain 509, upconverter gain 511, driver amplifier gain 513, PA gain 515 and/or desired output power 505 settings. For example, the communication device looks up the cumulative phase offset 517 in the same row as the desired output power 505 or corresponding gains 507, 509, 511, 513, 515, 517. The communication device may apply 741 the determined DAC gain 507, baseband filter gain 509, upconverter gain 511, driver amplifier gain 513 and/or PA gain 515. For example, the transmit gain controller 566 may send DAC gain control 560, baseband filter gain control 501, upconverter gain control 598, driver amplifier gain control 596 and/or PA gain control 564 signals to their corresponding modules. The control signals 560, 501, 598, 596, 564 are sent in accordance with the gain values 507, 509, 511, 513, 515 determined in the gain lookup table 503. The transmit gain controller may apply 743 baseband phase compensation to adjust for the cumulative phase offset 517. That is, the transmit gain controller 566 sends a baseband phase compensation signal 558 to the rotator 568 that indicates an amount of phase compensation to be applied (or the amount of phase shift that will be caused by a change in gain settings). Although they are depicted in a sequence in FIG. 7, applying 741 DAC gain, transmitter component gain and PA gain and applying 743 baseband phase compensation to compensate for cumulative phase offset may occur at the same time, or be synchronized.

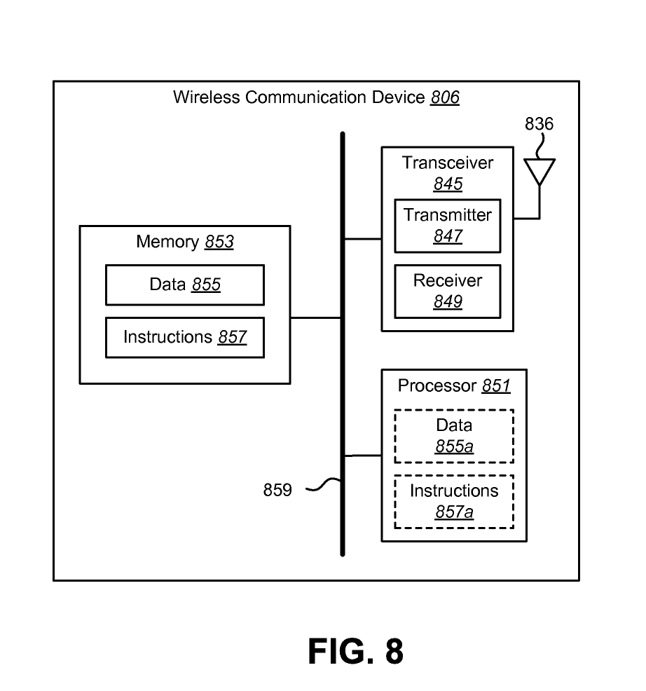

FIG. 8 illustrates certain components that may be included within a wireless communication device 806. The wireless communication devices 106 discussed previously may be configured similarly to the wireless communication device 806 shown in FIG. 8.

The wireless communication device 806 includes a processor 851. The processor 851 may be a general purpose single- or multi-chip microprocessor (e.g., an ARM), a special purpose microprocessor (e.g., a digital signal processor (DSP)), a microcontroller, a programmable gate array, etc. The processor 851 may be referred to as a central processing unit (CPU). Although just a single processor 851 is shown in the wireless communication device 806 of FIG. 8, in an alternative configuration, a combination of processors (e.g., an ARM and DSP) could be used.

The wireless communication device 806 also includes memory 853 in electronic communication with the processor 851 (i.e., the processor 851 can read information from and/or write information to the memory 853). The memory 853 may be any electronic component capable of storing electronic information. The memory 853 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 855 and instructions 857 may be stored in the memory 853. The instructions 857 may include one or more programs, routines, sub-routines, functions, procedures, etc. The instructions 857 may include a single computer-readable statement or many computer-readable statements. The instructions 857 may be executable by the processor 851 to implement the methods disclosed herein. Executing the instructions 857 may involve the use of the data 855 that is stored in the memory 853. FIG. 8 shows some instructions 857a and data 855a being loaded into the processor 851.

The wireless communication device 806 may also include a transmitter 847 and a receiver 849 to allow transmission and reception of signals between the wireless communication device 806 and a remote location (e.g., a base station). The transmitter 847 and receiver 849 may be collectively referred to as a transceiver 845. An antenna 836 may be electrically coupled to the transceiver 845. The wireless communication device 806 may also include (not shown) multiple transmitters, multiple receivers, multiple transceivers and/or multiple antenna.

The various components of the wireless communication device 806 may be coupled together by one or more buses, which may include a power bus, a control signal bus, a status signal bus, a data bus, etc. For simplicity, the various buses are illustrated in FIG. 8 as a bus system 859.

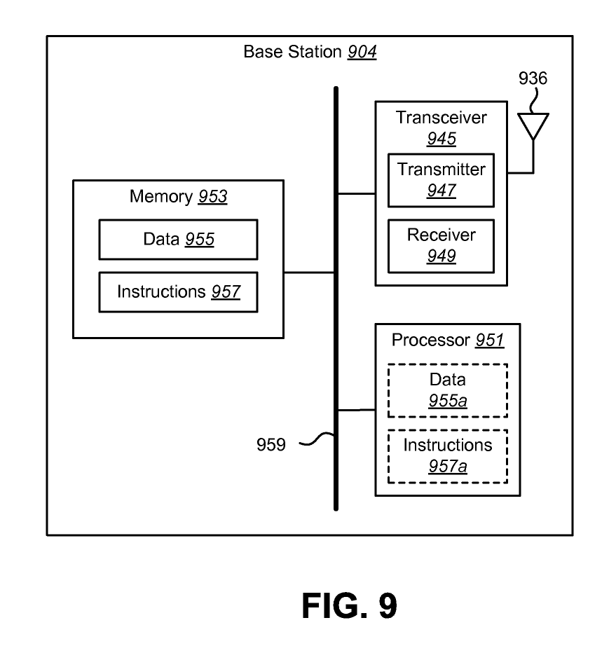

FIG. 9 illustrates certain components that may be included within a base station 904. The base stations 104 discussed previously may be configured similarly to the base station 904 that is shown in FIG. 9.

The base station 904 includes a processor 951. The processor 951 may be a general purpose single- or multi-chip microprocessor (e.g., an ARM), a special purpose microprocessor (e.g., a digital signal processor (DSP)), a microcontroller, a programmable gate array, etc. The processor 951 may be referred to as a central processing unit (CPU). Although just a single processor 951 is shown in the base station 904 of FIG. 9, in an alternative configuration, a combination of processors (e.g., an ARM and DSP) could be used.

The base station 904 also includes memory 953 in electronic communication with the processor 951 (i.e., the processor 951 can read information from and/or write information to the memory 953). The memory 953 may be any electronic component capable of storing electronic information. The memory 953 may be random access memory (RAM), read-only memory (ROM), magnetic disk storage media, optical storage media, flash memory devices in RAM, on-board memory included with the processor, programmable read-only memory (PROM), erasable programmable read-only memory (EPROM), electrically erasable PROM (EEPROM), registers, and so forth, including combinations thereof.

Data 955 and instructions 957 may be stored in the memory 953. The instructions 957 may include one or more programs, routines, sub-routines, functions, procedures, etc. The instructions 957 may include a single computer-readable statement or many computer-readable statements. The instructions 957 may be executable by the processor 951 to implement the methods that were described above in connection with the base stations 104. Executing the instructions 957 may involve the use of the data 955 that is stored in the memory 953. FIG. 9 shows some instructions 957a and data 955a being loaded into the processor 951.

The base station 904 may also include a transmitter 947 and a receiver 949 to allow transmission and reception of signals between the base station 904 and a remote location (e.g., a wireless communication device). The transmitter 947 and receiver 949 may be collectively referred to as a transceiver 945. An antenna 936 may be electrically coupled to the transceiver 945. The base station 904 may also include (not shown) multiple transmitters, multiple receivers, multiple transceivers and/or multiple antenna.

The various components of the base station 904 may be coupled together by one or more buses, which may include a power bus, a control signal bus, a status signal bus, a data bus, etc. For simplicity, the various buses are illustrated in FIG. 9 as a bus system 959.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a computer-readable medium. The term “computer-program product” or “computer-readable medium” refers to any available medium that can be accessed by a computer or processor. A computer-program product or computer readable medium may be non-transitory and tangible. By way of example, and not limitation, a computer-readable medium may comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for compensating for phase discontinuities on a communication device, comprising:
determining a desired output power on a communication device;
determining, on the communication device, a Digital-to-Analog Converter (DAC) gain corresponding to the desired output power;
determining, on the communication device, a cumulative phase offset based on the DAC gain or the desired output power;
applying the DAC gain to the communication device; and
applying, on the communication device, a phase compensation to a rotator to adjust for the cumulative phase offset.

2. The method of claim 1, wherein the phase compensation is synchronized with the application of the DAC gain.

3. The method of claim 1, wherein the phase discontinuities occur as a result of applying the DAC gain to the communication device.

4. The method of claim 1, further comprising:
determining, on the communication device, a gain of transmitter components;
determining, on the communication device, the cumulative phase offset, wherein determining the cumulative phase offset is further based on the gain of the transmitter components;
applying the gain of the transmitter components to the communication device; and
applying, on the communication device, the phase compensation to the rotator to adjust for the cumulative phase offset that is further based on the gain of the transmitter components.

5. The method of claim 4, wherein the phase compensation is synchronized with the application of the gain of the transmitter components.

6. The method of claim 4, wherein the phase discontinuities occur as a result of applying the gain of the transmitter components to the communication device.

7. The method of claim 4, wherein the transmitter components comprise a baseband filter.

8. The method of claim 4, wherein the transmitter components comprise an upconverter.

9. The method of claim 4, wherein the transmitter components comprise a Voltage Controlled Oscillator/Phase Lock Loop (VCO/PLL).

10. The method of claim 4, wherein the transmitter components comprise a driver amplifier.

11. The method of claim 4, wherein the phase discontinuities occur as a result of activating or deactivating at least one of the transmitter components or as a result of activating or deactivating at least one sub-block of the transmitter components.

12. The method of claim 1, further comprising:
determining, on the communication device, a Power Amplifier (PA) gain;
determining, on the communication device, the cumulative phase offset, wherein determining the cumulative phase offset is further based on the PA gain;
applying the PA gain to the communication device; and
applying, on the communication device, the phase compensation to the rotator to adjust for the cumulative phase offset that is further based on the PA gain.

13. The method of claim 12, wherein the phase compensation is synchronized with the application of the PA gain.

14. The method of claim 12, wherein the phase discontinuities occur as a result of applying the PA gain to the communication device.

15. The method of claim 1, wherein the phase compensation is applied via a single phase compensation path in the baseband of the communication device.

16. The method of claim 1, wherein the phase compensation is fine phase compensation.

17. The method of claim 1, wherein the communication device is a wireless communication device.

18. The method of claim 1, wherein the communication device is a base station.

19. The method of claim 1, wherein the phase compensation is always applied.

20. A communication device configured to compensate for phase discontinuities, comprising:
a modulator configured for modulating a baseband signal, wherein the modulator comprises a rotator configured for rotating a phase of the baseband signal;
a Digital-to-Analog Converter (DAC) configured for converting a modulated digital signal to an analog signal; and
a transmit gain controller configured to control a DAC gain and to provide a phase offset to the rotator in the modulator in order to compensate for a phase shift in a transmission chain, wherein the transmit gain controller selects the DAC gain and phase offset based on a desired output power.

21. The communication device of claim 20, wherein the phase offset is provided synchronously with the control of the DAC gain.

22. The communication device of claim 20, wherein the phase discontinuities occur as a result of controlling the DAC gain.

23. The communication device of claim 20, further comprising:
transmitter components configured to format a signal for transmission; and wherein
the transmit gain controller is further configured to control a gain of the transmitter components and to provide the phase offset to the rotator in the modulator in order to compensate for the phase shift in the transmission chain, wherein the transmit gain controller further selects the gain of the transmitter components based on the desired output power.

24. The communication device of claim 23, wherein the phase offset is provided synchronously with the control of the gain of the transmitter components.

25. The communication device of claim 23, wherein the phase discontinuities occur as a result of controlling the gain of the transmitter components.

26. The communication device of claim 23, wherein the transmitter components comprise a baseband filter.

27. The communication device of claim 23, wherein the transmitter components comprise an upconverter.

28. The communication device of claim 23, wherein the transmitter components comprise a Voltage Controlled Oscillator/Phase Lock Loop (VCO/PLL).

29. The communication device of claim 23, wherein the transmitter components comprise a driver amplifier.

30. The communication device of claim 23, wherein the phase discontinuities occur as a result of activating or deactivating at least one of the transmitter components or as a result of activating or deactivating at least one sub-block of the transmitter components.

31. The communication device of claim 20, further comprising:
a power amplifier (PA) configured to amplify a signal for transmission; and wherein
the transmit gain controller is further configured to control a PA gain and to provide the phase offset to the rotator in the modulator in order to compensate for the phase shift in the transmission chain, wherein the transmit gain controller further selects the PA gain based on the desired output power.

32. The communication device of claim 31, wherein the phase offset is provided synchronously with the control of the PA gain.

33. The communication device of claim 31, wherein the phase discontinuities occur as a result of controlling the PA gain.

34. The communication device of claim 20, wherein the compensation for the phase shift is applied via a single phase compensation path in the baseband of the communication device.

35. The communication device of claim 20, wherein the compensation for the phase shift is fine phase compensation.

36. The communication device of claim 20, wherein the communication device is a wireless communication device.

37. The communication device of claim 20, wherein the communication device is a base station.

38. The communication device of claim 20, wherein the compensation for the phase offset is always applied.

39. A computer-program product for compensating for phase discontinuities on a communication device, the computer-program product comprising a non-transitory tangible computer-readable medium having instructions thereon, the instructions comprising:
code for determining a desired output power;
code for determining a Digital-to-Analog Converter (DAC) gain corresponding to the desired output power;
code for determining a cumulative phase offset based on the DAC gain;
code for applying the DAC gain; and
code for applying a phase compensation to a rotator to adjust for the cumulative phase offset.

40. A communication device configured to compensate for phase discontinuities, comprising:
means for determining a desired output power on a communication device;
means for determining, on the communication device, a Digital-to-Analog Converter (DAC) gain corresponding to the desired output power;
means for determining, on the communication device, a cumulative phase offset based on the DAC gain or the desired output power;
means for applying the DAC gain to the communication device; and
means for applying, on the communication device, a phase compensation to a rotator to adjust for the cumulative phase offset.
